(19) United States
(12) Patent Application Publication
(10) Pub. No.: US 2025/0109227 A1
(43) Pub. Date: Apr. 3, 2025

(54) SINGLE ION CONDUCTING COPOLYMERS

(71) Applicant: BLUE SOLUTIONS CANADA INC., Boucherville (CA)

(72) Inventors: Qiujie ZHAO, Menlo Park, CA (US); Zijun WANG, Menlo Park, CA (US); John MALECHA, Menlo Park, CA (US); Jin YANG, Menlo Park, CA (US); Guillaume PINO, Boucherville (CA); Sarah DEGRAS, Brossard (CA); Dubora BAE, Menlo Park, CA (US); Josee RICHARD-DANIEL, Boucherville (CA)

(21) Appl. No.: 18/897,537

(22) Filed: Sep. 26, 2024

Related U.S. Application Data
(60) Provisional application No. 63/586,741, filed on Sep. 29, 2023.
(60) Provisional application No. 63/587,311, filed on Oct. 2, 2023.

(51) Int. Cl. C08F 228/02; H01M 10/0565

(52) U.S. Cl. CPC C08F 228/02; H01M 10/0565; H01M 2300/0082

(57) ABSTRACT

The present technology relates to copolymers of single ion conducting monomers and/or of neutral monomers, and relates to the methods of making them.

### CROSS-REFERENCE TO RELATED APPLICATIONS

This application claims the benefit of and priority to U.S. provisional patent application No. 63/586,741, filed on Sep. 29, 2023; and to U.S. provisional patent application No. 63/587,311, filed on Oct. 2, 2023; the content of both of which is herein incorporated in entirety by reference.

### TECHNICAL FIELD

The present technology generally relates to single ion conducting copolymers and to methods of copolymerizing single ion conducting monomers to obtain same.

### BACKGROUND

The need for reliable and long-lasting lithium batteries inspires the research on innovative electrolyte materials exhibiting improved performance with respect to conventional ones. State-of-the-art electrolytes for lithium batteries are based on mixtures of organic carbonates and fluorinated lithium salts. These liquid electrolytes allow for optimal battery operation under standard conditions. However, excessive temperature or high current loads may cause electrolyte decomposition, with consequent formation of flammable gas inside the battery case, and ultimately catastrophic battery failure. Solid polymer electrolytes (SPEs) represent a safer alternative to conventional electrolytes. SPEs offer high thermal stability, non-volatility, high electrochemical stability and prevent the risk of electrolyte leaks outside the battery case. Additionally, the use of SPEs simplify the battery design, thus increasing energy density.

Various types of solid polymer electrolytes adapted for use with lithium metal electrodes have been developed since the late 1970s. Single-ion conducting polymer electrolytes (SIPE) have, however, emerged as promising candidates, as the transference number of lithium cation approaches unity, and therefore prevents the formation of concentration gradients across the electrolyte.

Single-ion conducting polymers, specifically poly[(4-styrenesulfonyl) (trifluoromethanesulfonyl) imide] lithium salt (PSTFSI-Li), showed excellent performance as polymer electrolytes for Li battery applications due to its good conductivity, high electrochemical stability, and excellent cation transference number. However, the homopolymer tends to be difficult to process due to strong ionic interactions, and the precursors for synthesizing PSTFSI-Li remain expensive due to limited demands. In addition, it has poor compatibility when blending with other commercial polymers.

Therefore, there is a need for alternative or improved single-ion conducting polymer electrolytes which overcome or reduce at least some of the above-described problems.

### SUMMARY OF THE TECHNOLOGY

The inventors of the present technology have recently discovered that the introduction of a second monomer in a single ion conducting polymer present the following benefits: (1) reduction of polymer material costs; (2) better compatibility with other components in the polymer electrolyte formulations, (3) improved thermal properties (e.g., Tg and Td) to allow fast drying and better thermal stability; (4) more suitable mechanical properties (e.g., solution viscosity and modulus) which can enhance coating quality and the robustness of polymer electrolyte films; and (5) better electrochemical performance where the conductivity could be increased and the interfacial resistance with electrodes could be reduced.

According to one aspect, the present technology relates to a single ion conductive copolymer of Formula I:

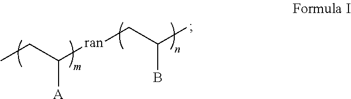

wherein monomer A is a single ion conducting monomer and monomer B is either a single ion conducting monomer or is a neutral monomer; ran is a random copolymer structure; m is an integer ranging from 1 to 5000; and n is an integer ranging from 1 to 5000.

According to another aspect, the present technology relates to a single-ion conducting polymer electrolyte comprising the single ion conductive copolymer as defined herein.

According to another aspect, the present technology relates to a single-ion conducting polymer cathode comprising the single ion conductive copolymer as defined herein.

According to another aspect, the present technology relates to a single-ion conducting polymer anode comprising the single ion conductive copolymer as defined herein.

According to another aspect, the present technology relates to a solid-state battery comprising a positive electrode, a negative electrode and the single-ion conducting polymer electrolyte as defined herein.

### BRIEF DESCRIPTION OF DRAWINGS

All features of embodiments which are described in this disclosure are not mutually exclusive and can be combined with one another. For example, elements of one embodiment can be utilized in the other embodiments without further mention. A detailed description of specific embodiments is provided herein below with reference to the accompanying drawings in which:

FIG. 1 is a graph showing 1H NMR of P288-006 (DMSO-d6), wherein Residual DMF peaks at: 7.95, 2.80 and 2.73 ppm STFSI units in random copolymer: 7.52, 6.97 ppm (—C₆H₄—SO₂—) and 1.6 ppm (—CH₂—CH—), no proton on the benzyl group in pentafluorostyrene.

FIG. 2 is a graph showing 19F NMR of P288-006 (DMSO-d6), wherein [3F from STFSI-Li]:[1F para from PFS]=100:19.1, thus for P288-006, [STFSI-Li]:[PFS]=1.75:1.

FIG. 3 is a graph showing GPC data of P288-006 (Mn=52.3 kDa, PDI=2.86).

FIG. 4 is a graph showing DSC data of P288-006 (2nd heating, 10 C/min, Tg=119° C.).

FIG. 5 is a graph showing 1H NMR of P292-001 (DMSO-d6), wherein Residual DMF peak at: 7.95, 2.80 and 2.73 ppm STFSI units in random copolymer: 7.52, 6.97 ppm (—C₆H₄—SO₂—) and 1.6 ppm (—CH₂—CH—) TFEMA units in random copolymer: 4.0-4.5 ppm (—COO—CH₂—CF₃), 0-1 ppm (—CH₃).

FIG. 6 is a graph showing 19F NMR of P292-001 (DMSO-d6), wherein —COO—CH₂—CF₃ from TFEMA at −72.5 ppm, N(Li)—SO₂—CF₃ from STFSI at −78.1 ppm. STFSI:TFEMA final ratio in random copolymer=1:0.8.

FIG. 7 is a graph showing GPC data of P292-001 (Mn=178 kDa, PDI=2.62).

FIG. 8 is a graph showing DSC data of P292-001 (2nd heating, 10 C/min, Tg=123° C.).

### DETAILED DESCRIPTION

### Definition

The use of “including”, “comprising”, or “having”, “containing”, “involving” and variations thereof herein, is meant to encompass the items listed thereafter as well as, optionally, additional items.

It must be noted that, as used in this specification and the appended claims, the singular form “a”, “an” and “the” include plural referents unless the context clearly dictates otherwise.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

As used herein, the expression “single-ion conducting monomer” is a monomer comprising an immobile anion as part of its chemical structure.

As used herein, the expression “single-ion conducting copolymer” is a copolymer comprising an immobile anion as part of its chemical structure.

As used herein, the expression “immobile anion” refers to anions which are not displaced during the charge/discharge cycles of a battery comprising them.

As used herein, the term “about” in the context of a given value or range refers to a value or range that is within 20%, preferably within 10%, and more preferably within 5% of the given value or range.

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting.

Broadly, the present technology relates to copolymers of single ion conducting monomers and/or of neutral monomers, and relates to the methods of making them.

The present technology also relates to the use of the copolymers of single ion conducting monomers and/or of neutral monomers as electrolytes for use in solid state lithium batteries.

In one embodiment, the copolymers of the present technology have a random copolymer structure. In some instances, the random polymer structure comprises two different vinyl-based monomers, one or both of which has single ion conducting capability. As used herein, a “random copolymer” refers to a copolymer wherein the distribution of monomeric units is statistically random.

In one embodiment, the copolymer of the present technology has as structure as depicted in Formula I:

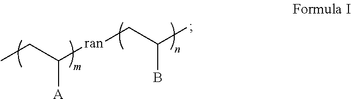

wherein monomer A is a single ion conducting monomer and monomer B is either a single ion conducting monomer or is a neutral monomer;
ran is a random copolymer structure;
m is an integer ranging from 1 to 5000; and
n is an integer ranging from 1 to 5000.

In some embodiments, monomer A is the single ion conducting monomer and monomer B is a single ion conducting monomer. In some other embodiments, monomer A is the single ion conducting monomer and monomer B is a neutral monomer.

In one embodiment, the copolymers of the present technology is prepared by simultaneous polymerization of monomer A and monomer B in a homogeneous mixture.

In one embodiment, one of monomer A and monomer B or both is a sulfonate monomer.

In one embodiment, one of monomer A and monomer B or both has a structure as depicted in Formula II:

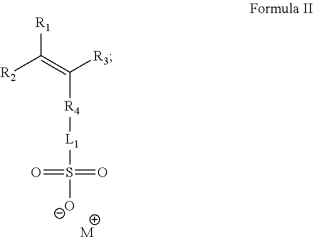

wherein R₁, R₂ are each independently H or F;
R₃ is H, F, CN or CH₃;
R₄ is: (1) an ester group (either —(C═O)—O— or —O—(C═O)—), (2) An aromatic group with L₁ substituted at ortho/para/meta position, (3) a fully or partially fluorinated aromatic group with L₁ substituted at ortho/para/meta position, (4) an amide group (—(C═O)—NH—), (5) a carbonate group (—O—(C═O)—O—), or (6) an ether group (—O—);
L₁ is a n-alkyl group (n=1-16), a fluorinated alkyl group (C₁-C₁₆), a branched alkyl group (C₃-C₁₆), an ethylene oxide linker (C₄ to C₁₆), a fluorinated ethylene oxide linker (C₄ to C₁₆), a cycloalkyl group (C₄ to C₇), a fluorinated cycloalkyl group (C₄ to C₇) or absent; and
M is monovalent cation H⁺, Li⁺, Na⁺, K⁺, Rb⁺ or Cs⁺.

In another embodiment, one of monomer A and monomer B or both is a fluorinated sulfonimide monomer.

In one embodiment, one of monomer A and monomer B or both has a structure as depicted in Formula III:

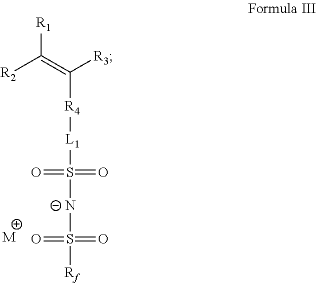

wherein R₁, R₂ are each independently H or F;
R₃ is H, F, CN or CH₃;
R₄ is: (1) an ester group (either —(C═O)—O— or —O—(C═O)—), (2) an aromatic group with L₁ substituted at ortho/para/meta position, (3) a fully or partially fluorinated aromatic group with L₁ substituted at ortho/para/meta position, (4) an amide group (—(C═O)—NH—), (5) a carbonate group (—O—(C═O)—O—), or (6) an ether group (—O—);
L₁ is a n-alkyl group (n=1-16), a fluorinated alkyl group (C₁-C₁₆), a branched alkyl group (C₃-C₁₆), an ethylene oxide linker (C₄ to C₁₆), a fluorinated ethylene oxide linker (C₄ to C₁₆), a cycloalkyl group (C₄ to C₇), a fluorinated cycloalkyl group (C₄ to C₇) or is absent;
R_{f} is selected from F, CF₃, CF₂H, CFH₂, (CF₂)nCF₃ (wherein n=1-16), C₆F₅, a branched C₃-C₄ fluoroalkyl group, —(CF₂CF₂O)n-CF₂CF₃ (wherein n=1, 2 or 3), and an aryl substituted with at least one fluorine and at least one electron-withdrawing group;
the electron withdrawing group is selected from —CN, —NO₂, —CF₃, and —SO₂CF₃; and
M is monovalent cation H⁺, Li⁺, Na⁺, K⁺, Rb⁺ or Cs⁺.

In another embodiment, one of monomer A and monomer B or both is a fluorinated sulfonyl carbamate monomer.

In one embodiment, on of monomer A and monomer B or both has a structure as depicted in Formula IV:

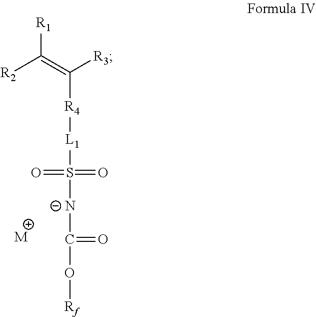

wherein R₁, R₂ are each independently H or F;
R₃ is H, F, CN or CH₃;
R₄ is: (1) an ester group (either —(C═O)—O— or —O—(C═O)—), (2) an aromatic group with L₁ substituted at ortho/para/meta position, (3) a fully or partially fluorinated aromatic group with L₁ substituted at ortho/para/meta position, (4) an amide group (—(C═O)—NH—), (5) a carbonate group (—O—(C═O)—O—), or (6) an ether group (—O—);
L₁ is a n-alkyl group (n=1-16), a fluorinated alkyl group (C₁-C₁₆), a branched alkyl group (C₃-C₁₆), an ethylene oxide linker (C₄ to C₁₆), a fluorinated ethylene oxide linker (C₄ to C₁₆), a cycloalkyl group (C₄ to C₇), a fluorinated cycloalkyl group (C₄ to C₇) or is absent;
Rf is selected from F, CF₃, CF₂H, CFH₂, (CF₂)ₙCF₃ (wherein n=1-16), C₆F₅, a branched C₃-C₄ fluoroalkyl group, —(CF₂CF₂O)n-CF₂CF₃ (wherein n=1, 2 or 3), and an aryl substituted with at least one fluorine and at least one electron-withdrawing group;
the electron withdrawing group is selected from —CN, —NO₂, —CF₃, and —SO₂CF₃; and
M is monovalent cation H⁺, Li⁺, Na⁺, K⁺, Rb⁺ or Cs⁺.

In another embodiment, one or monomer A and monomer B or both is a fluorinated sulfonamide monomer.

In one embodiment, one of monomer A and monomer B or both have a structure as depicted in Formula V:

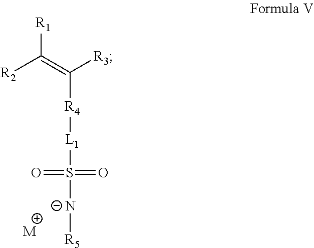

wherein R₁, R₂ are both independently H or F;
R₃ is H, F, CN or CH₃;
R₄ is: (1) an ester group (either —(C═O)—O— or —O—(C═O)—), (2) an aromatic group with L₁ substituted at ortho/para/meta position, (3) a fully or partially fluorinated aromatic group with L₁ substituted at ortho/para/meta position, (4) an amide group (—(C═O)—NH—), (5) a carbonate group (—O—(C═O)—O—), or (6) an ether group (—O—);
L₁ can be a n-alkyl group (n=1-16), a fluorinated alkyl group (C₁-C₁₆), a branched alkyl group (C₃-C₁₆), an ethylene oxide linker (C₄ to C₁₆), a fluorinated ethylene oxide linker (C₄ to C₁₆), a cycloalkyl group (C₄ to C₇), a fluorinated cycloalkyl group (C₄ to C₇) or is absent;
R₅ is selected from: CN, CX₃, CX₂H, CXH₂ (where X=F, Cl, Br, I), fully or partially halogenated alkyl group (C₂-C₁₆), C₆F₅, a branched C₃-C₄ fluoroalkyl group, —(CF₂CF₂O)ₙ-CF₂CF₃ (wherein n=1, 2 or 3), and an aryl substituted with at least one fluorine and at least one electron-withdrawing group (—CN, —NO₂, —CF₃, or —SO₂CF₃); and
M is a monovalent cation and it can be H⁺, Li⁺, Na⁺, K⁺, Rb⁺ or Cs⁺.

In another embodiment, one of monomer A and monomer B or both is a fluorinated sulfonylmethide monomer.

In one embodiment, one of monomer A and monomer B or both has a structure as depicted in Formula V:

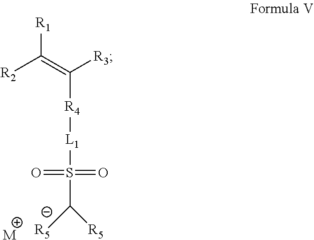

wherein R₁, R₂ are independently H or F;
R₃ is H, F, CN or CH₃;
R₄ is: (1) an ester group (either —(C═O)—O— or —O—(C═O)—), (2) an aromatic group with L₁ substituted at ortho/para/meta position, (3) a fully or partially fluorinated aromatic group with L₁ substituted at ortho/para/meta position, (4) an amide group (—(C═O)—NH—), (5) a carbonate group (—O—(C═O)—O—), or (6) an ether group (—O—);
L₁ is a n-alkyl group (n=1-16), a fluorinated alkyl group (C₁-C₁₆), a branched alkyl group (C₃-C₁₆), an ethylene oxide linker (C₄ to C₁₆), a fluorinated ethylene oxide linker (C₄ to C₁₆), a cycloalkyl group (C₄ to C₇), a fluorinated cycloalkyl group (C₄ to C₇) or is absent,
R₅ is selected from: CN, CX₃, (where X=F, Cl, Br, I), SO₂R, CO₂R (R could be alkyl, aryl, perfluoroalkyl, or perfluoroaryl group), and an aryl substituted with at least one fluorine and at least one electron-withdrawing group (—CN, —NO₂, —CF₃, or —SO₂CF₃); and
M is monovalent cation H⁺, Li⁺, Na⁺, K⁺, Rb⁺ or Cs⁺.

In another embodiment, one of monomer A and monomer B or both is a fluorinated monocyclic borate monomer.

In one embodiment, one of monomer A and monomer B or both has a structure as depicted in Formula VI:

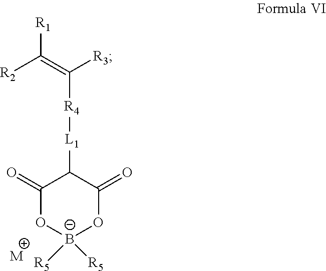

wherein R₁, R₂ are independently H or F;
R₃ is H, F, CN or CH₃;
R₄ is: (1) an ester group (either —(C═O)—O— or —O—(C═O)—), (2) an aromatic group with L₁ substituted at ortho/para/meta position, (3) a fully or partially fluorinated aromatic group with L₁ substituted at ortho/para/meta position, (4) an amide group (—(C═O)—NH—), (5) a carbonate group (—O—(C═O)—O—), or (6) an ether group (—O—);
L₁ is a n-alkyl group (n=1-16), a fluorinated alkyl group (C1-C16), a branched alkyl group (C₃-C₁₆), an ethylene oxide linker (C₄ to C₁₆), a fluorinated ethylene oxide linker (C₄ to C₁₆), a cycloalkyl group (C₄ to C₇), a fluorinated cycloalkyl group (C₄ to C₇) or is absent;
R₅ is selected from: F, OCX₃(X=F, Cl, Br, I), OCF₂H, OCFH₂, O(CF₂)ₙCF₃ (n=1-16), a branched fluoroalkoxy group (C₃-C₁₆), OC₆F₅, O(CF₂CF₂O)ₙ-CF₂CF₃ (wherein n=1, 2 or 3), and an aryloxy substituted with at least one fluorine and at least one electron-withdrawing group;
the electron withdrawing group is selected from —CN, —NO₂, —CF₃, and —SO₂CF₃; and
M is monovalent cation H⁺, Li⁺, Na⁺, K⁺, Rb⁺ or Cs⁺.

In another embodiment, one of monomer A and monomer B or both is a fluorinated bicyclic borate monomer.

In one embodiment, one of monomer A and monomer B or both has a structure as depicted in Formula VII:

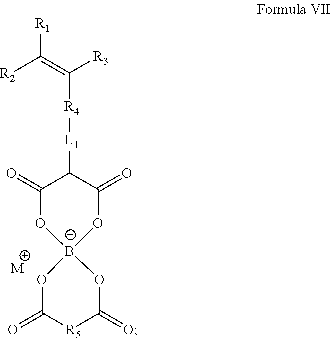

wherein R₁, R₂ are independently H or F;
R₃ is H, F, CN or CH₃;
R₄ is: (1) an ester group (either —(C═O)—O— or —O—(C═O)—), (2) an aromatic group with L₁ substituted at ortho/para/meta position, (3) a fully or partially fluorinated aromatic group with L₁ substituted at ortho/para/meta position, (4) an amide group (—(C═O)—NH—), (5) a carbonate group (—O—(C═O)—O—), or (6) an ether group (—O—);
L₁ is a n-alkyl group (n=1-16), a fluorinated alkyl group (C₁-C₁₆), a branched alkyl group (C₃-C₁₆), an ethylene oxide linker (C₄ to C₁₆), a fluorinated ethylene oxide linker (C₄ to C₁₆), a cycloalkyl group (C₄ to C₇), a fluorinated cycloalkyl group (C₄ to C₇) or is absent;
R₅ is: an n-alkyl group (C₁-C₁₆), a branched alkyl group (C₃-C₁₆), a mono-unsaturated alkyl group (C₂-C₁₆), a di-unsaturated alkyl group (C₄-C₁₆), a branched unsaturated alkyl group (C₃-C₁₆), a fluorinated alkyl group (C₁-C₁₆), a cycloalkyl group (C₄ to C₇), a fluorinated cycloalkyl group (C₄ to C₇), or an aryl group substituted with at least one fluorine and at least one electron-withdrawing group;
the electron withdrawing group is selected from —CN, —NO₂, —CF₃, and —SO₂CF₃; and
M is monovalent cation H⁺, Li⁺, Na⁺, K⁺, Rb⁺ or Cs⁺.

In another embodiment, one of monomer A and monomer B or both is each a fluorinated noncyclic borate monomer.

In one embodiment, one of monomer A and monomer B or both has a structure as depicted in Formula VIII:

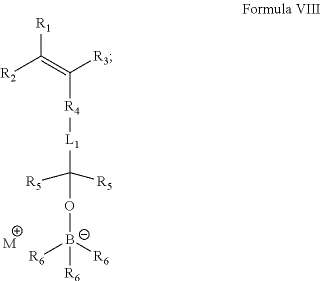

wherein R₁, R₂ are independently H or F;
R₃ is H, F, CN or CH₃;
R₄ is: (1) an ester group (either —(C═O)—O— or —O—(C═O)—), (2) an aromatic group with L₁ substituted at ortho/para/meta position, (3) a fully or partially fluorinated aromatic group with L₁ substituted at ortho/para/meta position, (4) an amide group (—(C═O)—NH—), (5) a carbonate group (—O—(C═O)—O—), or (6) an ether group (—O—);
L₁ is a n-alkyl group (n=1-16), a fluorinated alkyl group (C1-C16), a branched alkyl group (C₃-C₁₆), an ethylene oxide linker (C₄ to C₁₆), a fluorinated ethylene oxide linker (C₄ to C₁₆), a cycloalkyl group (C₄ to C₇), a fluorinated cycloalkyl group (C₄ to C₇) or is absent;
R₅ is: F, CN, NO₂, CX₃(X=F, Cl, Br, I), CF₂H, CFH₂, (CF₂)ₙCF₃ (n=1-16), a branched fluoroalkyl group (C₃-C₁₆), C₆F₅, (CF₂CF₂O)ₙ-CF₂CF₃ (wherein n=1, 2 or 3), and an aryl substituted with at least one fluorine and at least one electron-withdrawing group;
the electron withdrawing group is selected from —CN, —NO₂, —CF₃, and —SO₂CF₃;
R6 is selected from: F, OCX₃(X=F, Cl, Br, I), OCF₂H, OCFH₂, O(CF₂)ₙCF₃ (n=1-16), a branched fluoroalkoxy group (C₃-C₁₆), OC₆F₅, O(CF₂CF₂O)ₙ-CF₂CF₃ (wherein n=1, 2 or 3), and an aryloxy substituted with at least one fluorine and at least one electron-withdrawing group. The electron withdrawing group is selected from —CN, —NO₂, —CF₃, and —SO₂CF₃; and
M is monovalent cation H⁺, Li⁺, Na⁺, K⁺, Rb⁺ or Cs⁺.

In another embodiment, monomer B is a styrene derivative.

In one embodiment, monomer B has a structure as depicted in Formula IX:

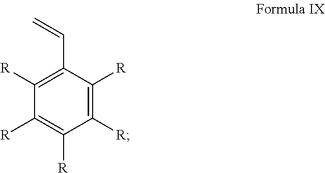

wherein each R group independently is: H, F, Cl, Br, I, CN, CH₃, OCH₃, n-alkyl group (C₂-C₁₆), branched alkyl group (C₃-C₆), CHₙX₃₋ₙ, (X=F, Cl, Br or I, n=0-2), CH₂CF₃CH₂(CF₂)ₙCF₃, (n=1-16) (CF₂)ₙCF₃ (n=1-16), an acrylate group (—CH₂—O(C═O)—CH═CH₂), an methacrylate group (—CH₂—O(C═O)—C(CH₃)═CH₂), an alkyl phosphate group (CH₂)ₘ-(P═O)—(O(CH₂)ₙCH₃)₂ (m=1-16, n=0-16), or an ether-alkyl phosphate group —CH₂—O—(CH₂)m-(P═O)—(O(CH₂)ₙCH₃)₂ (m=1-16, n=0-16).

In another embodiment, monomer B is an acrylate or a methacrylate derivative.

In one embodiment, monomer B has a structure as depicted in Formula X:

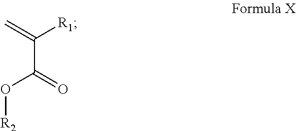

wherein R₁ is H or CH₃;
R₂ is: CH₃, n-alkyl group (C₂-C₁₆), branched alkyl group (C₃-C₆), CHₙX₃₋ₙ, (X=F, Cl, Br, I, n=0-2), CH₂CF₃, CH₂(CF₂)ₙCF₃, (n=1-16), (CF₂)ₙCF₃ (n=1-16), (CH₂)ₘ-(P═O)—(O(CH₂)ₙCH₃)₂ (m=1-16, n=0-16).

In another embodiment, monomer B is a vinyl carbonate derivative.

In one embodiment, monomer B has a structure as depicted in Formula XII:

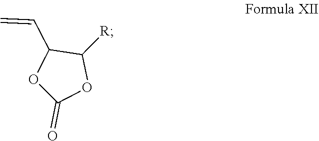

wherein R is: H, F, Cl, Br, I, CN, CH3, OCH₃, n-alkyl group (C₂-C₁₆), branched alkyl group (C₃-C₆), CHₙX₃₋ₙ, (X=F, Cl, Br or I, n=0-2), CH₂CF₃, CH₂(CF₂)ₙCF₃, (n=1-16), (CF₂)ₙCF₃ (n=1-16).

In another embodiment, monomer B is any other vinyl monomer.

In one embodiment, monomer B has a structure as depicted in Formula XIII:

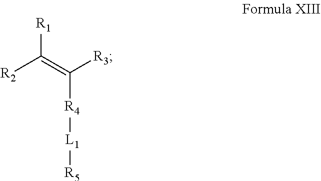

wherein R₁, R₂ are independently H or F;
R₃ is H, F, Cl, Br, I, CN or CH₃;
R₄ is: (1) an amide group (—(C═O)—NH—), (2) a carbonate group (—O—(C═O)—O—), (3) an ether group (—O—), (4) a carbonyl group (—(C═O)—) or is absent;
L₁ is: a n-alkyl group (n=1-16), a fluorinated alkyl group (C₁-C₁₆), a hydroxyl-containing alkyl group (C₁-C₁₆), a amine-containing alkyl group (C₁-C₁₆), a branched alkyl group (C₃-C₁₆), a hydroxyl-containing branched alkyl group (C₃-C₁₆), a amine-containing branched alkyl group (C₃-C₁₆), an ethylene oxide linker (C4 to C16), a fluorinated ethylene oxide linker (C₄ to C₁₆), a cycloalkyl group (C₄ to C₇), a fluorinated cycloalkyl group (C₄ to C₇) or is absent;
R₅ is: H, CN, F, Cl, Br, I, CXₙH₃₋ₙ(X=F, Cl, Br, I, n=0-3), OH, NH₂, NO₂, SH, aldehyde (COH), carboxylic acid (COOH), alkyl ether (—O—(CH₂)ₙCH₃, n=0-5), a partially or fully fluorinated alkyl ether (C₁-C₆), alkyl ketone (—(C═O)—(CH₂)ₙCH₃, n=0-5), a partially or fully fluorinated alkyl ketone (C₁-C₆), alkyl ester (—COO—(CH₂)ₙCH₃, n=0-5), a partially or fully fluorinated alkyl ester (C₁-C₆), alkyl sulfide (—S—(CH₂)ₙCH₃, n=0-5), a vinyl group (—CH═CH₂), a cycloalkyl group (C₄-C₇), a fully or partially halogenated cycloalkyl group (C₄-C₇), a benzyl group, a fully or partially halogenated benzyl group, a naphthalene group, an epoxy group, a furan group, a tetrahydrofuran group, a dioxane group, a lactone group (C₃-C₁₀), a secondary alkyl amine (C₁-C₆), a tertiary alkyl amine (C₁-C₆), an amide group (C₁-C₆), a N-alkyl amide group (C₂-C₁₂), an imidazole group, a pyrrolidine group, a pyrrole group, a piperidine group, a pyridine group, a lactam group (C₃-C₈), a N-alkyl lactam group (C₁-C₆ alkyl substitution, C₃-C₁₀ for cyclic carbons), a phthalimide group (—N—(C═O)₂—C₆H₄), or a thiophene group.

In one embodiment, monomer B has a structure as depicted in Formula XIV:

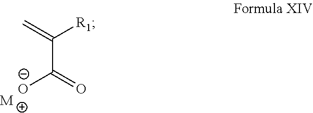

wherein R₁ is H or CH₃; and
M is monovalent cation H⁺, Li⁺, Na⁺, K⁺, Rb⁺ or Cs⁺.

In one embodiment, the single ion conducting monomers of the present technology are made according to methods as discussed in PCT/CA2023/050984, incorporated herein by reference.

In some instances, the methods of the present technology comprise polymerizing the single-ion monomers as described herein to obtain a single-ion copolymer. In certain instances, polymerization may be performed by controlled polymerization (ATRP (“Atom Transfer Radical Polymerization”), RAFT (“Reversible Addition Fragmentation Chain Transfer”), anionic polymerization, cationic polymerization, free radical polymerization, or NMP (“Nitroxide-Mediated Radical Polymerization”)).

In one embodiment, the copolymer of the present technology is:

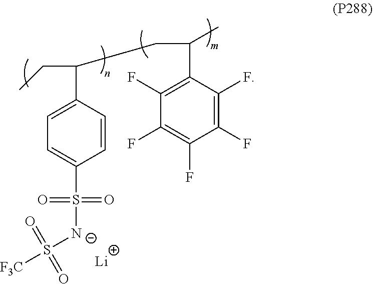

In one embodiment, the copolymer of the present technology is:

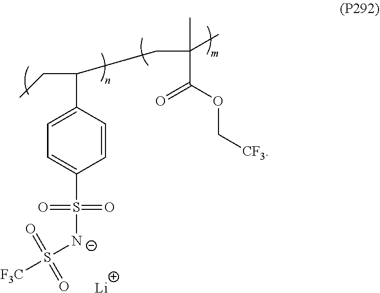

In one embodiment, the copolymer of the present technology is:

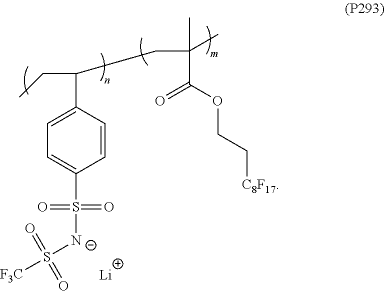

In one embodiment, the copolymer of the present technology is:

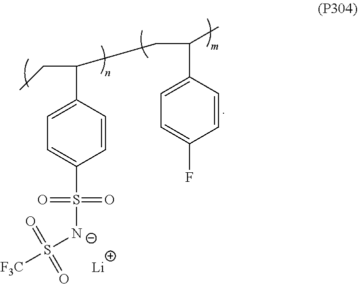

In one embodiment, the copolymer of the present technology is:

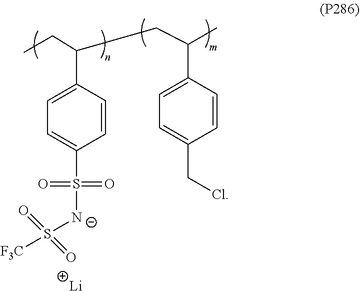

In one embodiment, the copolymer of the present technology is:

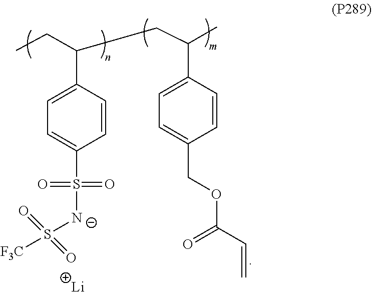

In one embodiment, the copolymer of the present technology is:

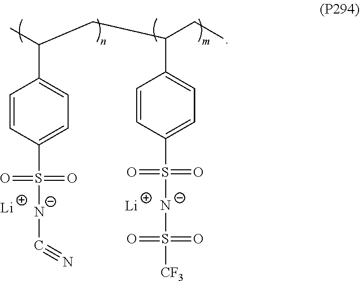

In one embodiment, the copolymer of the present technology is:

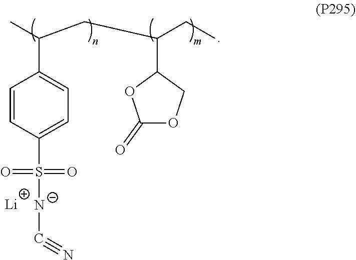

In one embodiment, the copolymer of the present technology is:

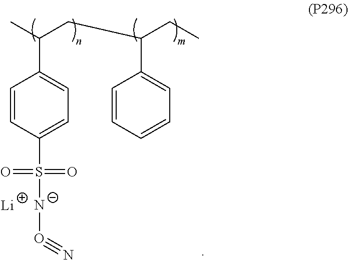

In one embodiment, the copolymer of the present technology is:

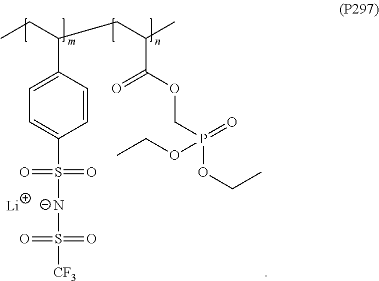

In one embodiment, the copolymer of the present technology is:

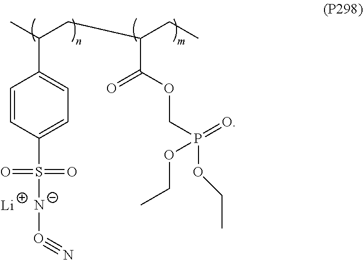

In one embodiment, the copolymer of the present technology is:

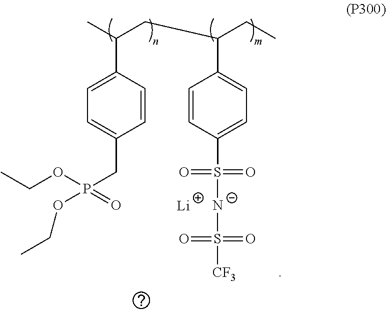

In one embodiment, the copolymer of the present technology is:

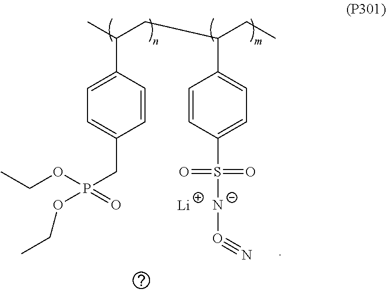

In one embodiment, the copolymer of the present technology is:

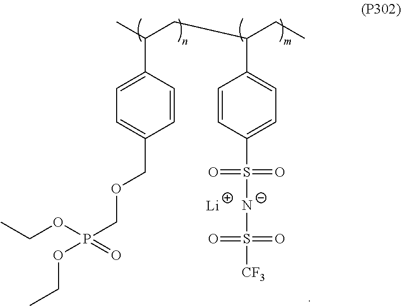

In one embodiment, the copolymer of the present technology is:

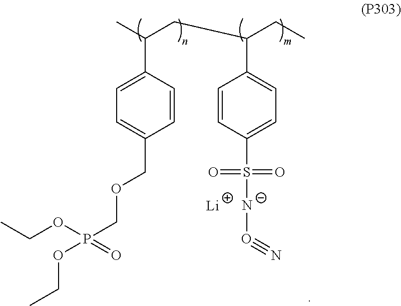

In one embodiment, the copolymer of the present technology is:

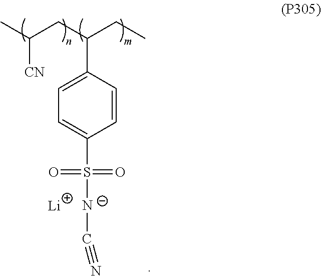

In one embodiment, the copolymer of the present technology is:

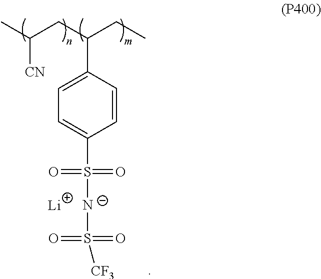

In one embodiment, the copolymer of the present technology is:

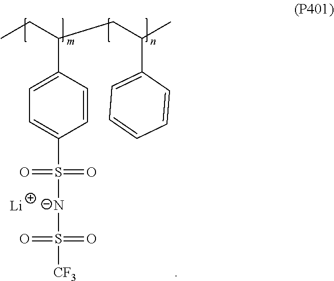

In one embodiment, the copolymer of the present technology is:

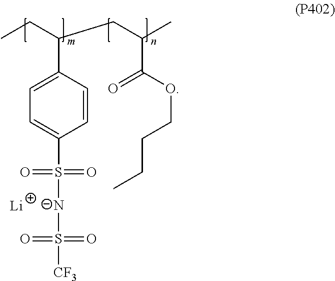

In one embodiment, the copolymer of the present technology is:

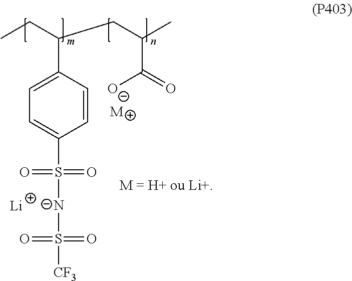

In one embodiment, the copolymer of the present technology is:

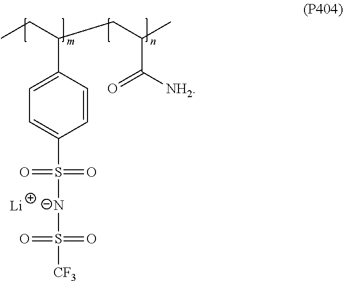

In one embodiment, the copolymer of the present technology is:

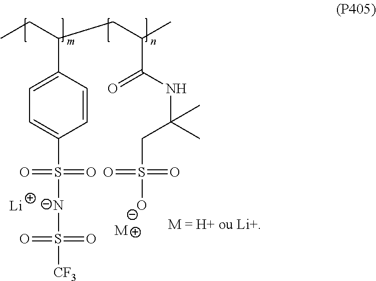

In one embodiment, the copolymer provided by the present technology can serve as solid state lithium ion battery electrolyte such as a or as lithium cell electrolyte. In some instances, the copolymers of the present technology can form part of a polymer electrolyte film.

In one embodiment, the present invention provides a solid state lithium ion battery that uses the copolymers of the present technology in the electrolyte.

In one embodiment, the present invention provides a solid state lithium ion battery that uses the copolymers of the present technology in the cathode.

In one embodiment, the present invention provides a solid state lithium ion battery that uses the copolymers of the present technology in the anode.

The solid state lithium battery of the present technology comprises a first and a second electrodes and an electrolyte. The first and second electrodes (i.e., the anode and the cathode) include suitable conducting materials such as known in the art to be used in electrochemical devices including any primary (non-rechargeable) or secondary (rechargeable) battery chemistries. The anodes and cathodes could be comprised of any materials exhibiting oxidation/reduction couple reactions where the difference in standard electrode potential is greater than approximately 0.1 V.

At least one of the anode and cathode may further be coated with an electrically conductive material such as conducting carbon, conducting metals, conducting polymers, or with an ionic conductive material such as ionic conducting polymers (e.g., the single-ion conducting copolymer of the present technology), and combinations thereof.

### EXAMPLES

The examples below are given to illustrate the practice of various embodiments of the present disclosure. They are not intended to limit or define the entire scope of this disclosure.

### Example 1: Synthesis of Poly(STFSI-Li-Co-Pentafluorostyrene) (P288)

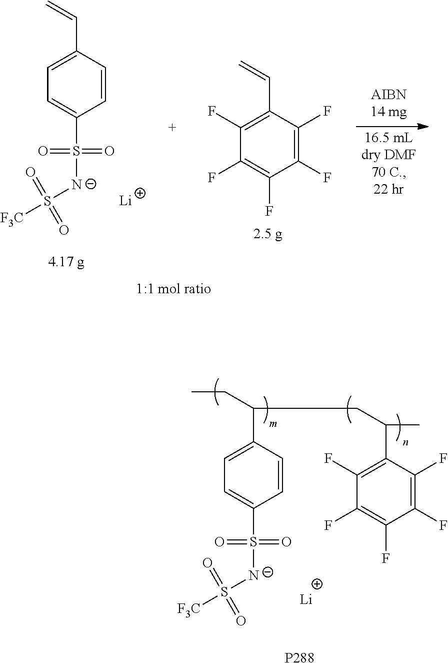

STFSI-Li monomer was made according to methods as discussed in PCT/CA2023/050984, incorporated herein by reference.

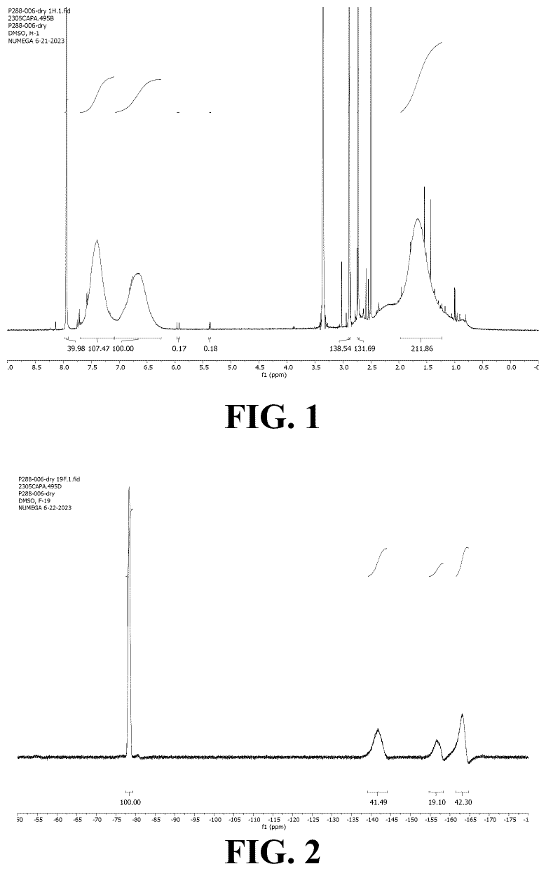

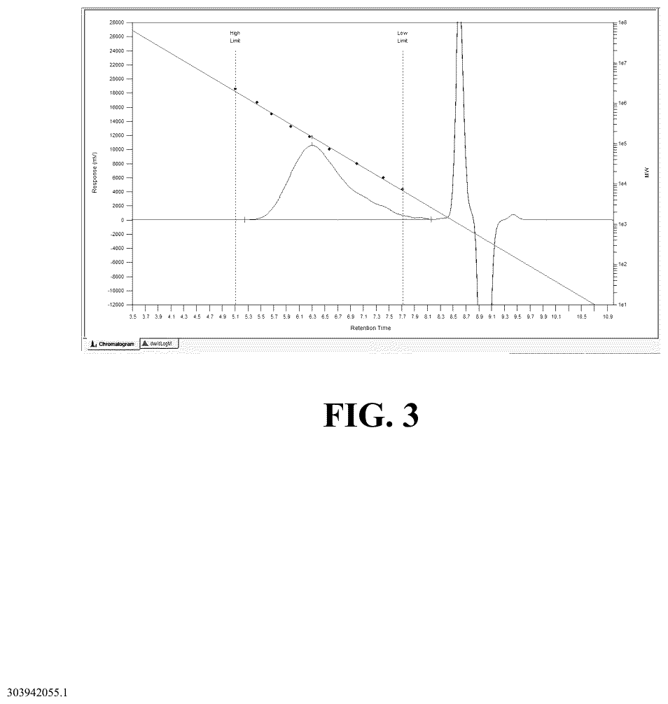

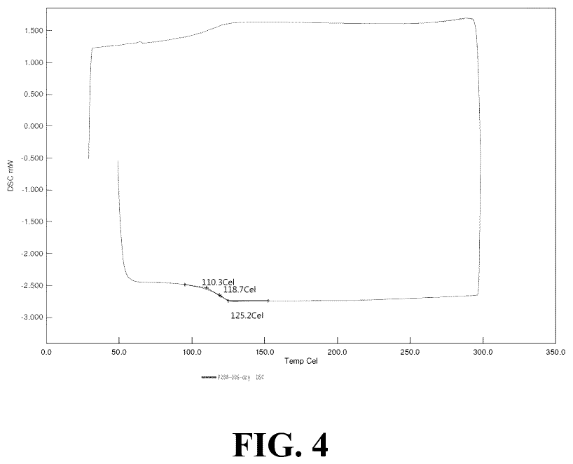

To make the P(STFSI-co-PFS) random copolymer, STFSI-Li (recrystallized, 4.17 g, 13.0 mmol) was mixed with pentafluorostyrene (PFS, Sigma-Aldrich, 2.5 g, 12.9 mmol) and AIBN initiator (Sigma-Aldrich, 14 mg, 0.085 mmol) in 16.5 mL anhydrous DMF. The solution was purged with Ar for ˜1 hr and heating at 70 C for ˜22 hrs. The DMF solution was then precipitated in diethyl ether three times. The polymer was vac-dried at 110° C. for ˜24 hrs. The final copolymer mol ratio is STFSI:PFS=1.75:1 (based on 19F NMR). Mn=52.3 kDa, PDI=2.86 (GPC, DMF+LiBr, 50° C., 1 ml/min). Tg=119° C. (DSC, 2^{nd} heating, 10° C./min) (FIG. 1, FIG. 2, FIG. 3 and FIG. 4).

### Example 2: Synthesis of Poly(STFSI-Li-Co-Trifluoroethyl Methacrylate) (P292)

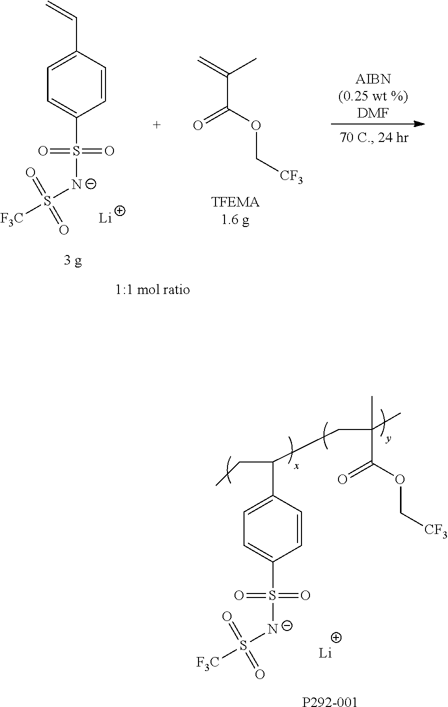

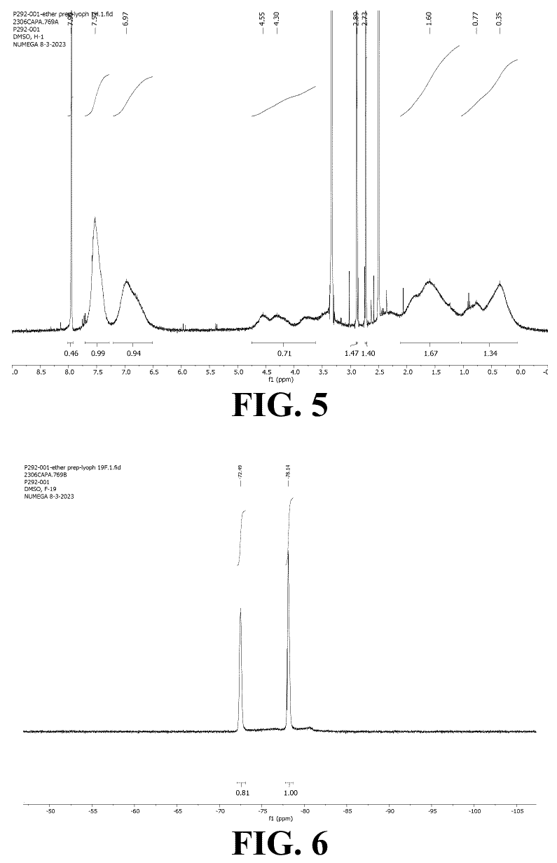

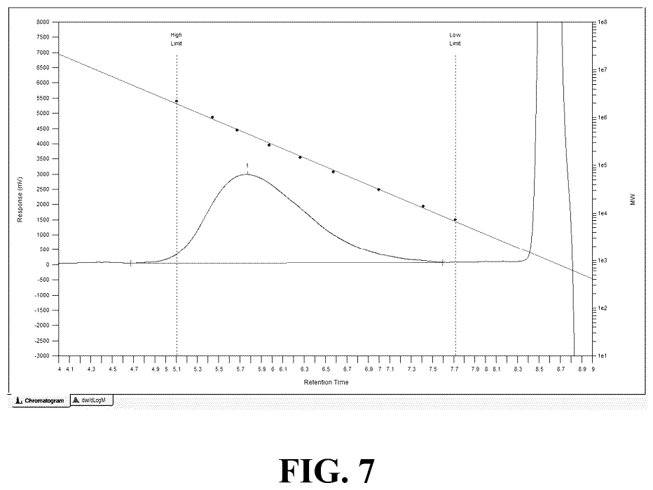

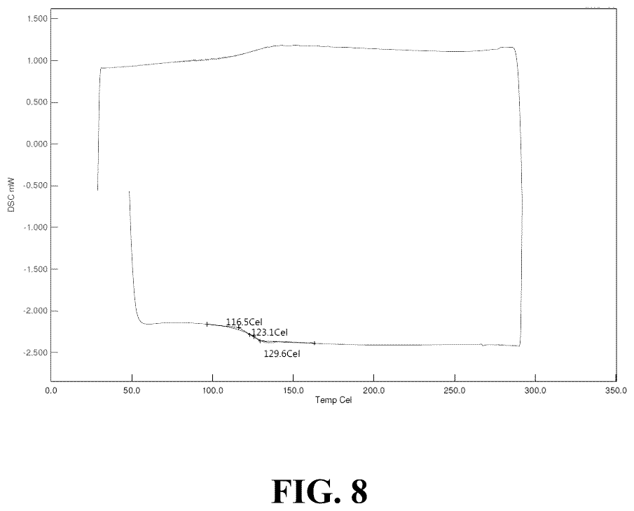

To make the P(STFSI-co-TFEMA) random copolymer, STFSI-Li (recrystallized, 3.00 g, 9.34 mmol) was mixed with 2,2,2-trifluoroethyl methacrylate (TFEMA, Sigma-Aldrich, 1.59 g, 9.46 mmol) and AIBN initiator (Sigma-Aldrich, 11.7 mg, 0.07 mmol) in 10 mL anhydrous DMF in a 20 mL vial. Both monomers are fully soluble in DMF. The solution was purged with Ar for ˜1 hr and heating at 70 C for ˜24 hrs. The DMF solution was then precipitated in 100 mL diethyl ether. The viscous precipitate was redissolved in methanol and precipitated into diethyl ether twice more. The polymer was vac-dried at 60° C. for 19 hrs. The hard solid was dissolved in water and freeze-dried to give 4.3 g white powder (93% yield). The final copolymer mol ratio is STFSI:TFEMA=1:0.8 (based on 19F NMR). Mn=148 kDa, PDI=2.62 (GPC, DMF+LiBr, 50° C., 1 ml/min). Tg=123° C. (DSC, 2^{nd} heating, 10° C./min) (FIG. 5).

Variations and modifications will occur to those of skill in the art after reviewing this disclosure. The disclosed features may be implemented, in any combination and subcombinations (including multiple dependent combinations and subcombinations), with one or more other features described herein. The various features described or illustrated above, including any components thereof, may be combined or integrated in other systems. Moreover, certain features may be omitted or not implemented. Examples of changes, substitutions, and alterations are ascertainable by one skilled in the art and could be made without departing from the scope of the information disclosed herein.

It should be appreciated that the present technology is not limited to the particular embodiments described and illustrated herein but includes all modifications and variations falling within the scope of the present technology as defined in the appended claims.

All references cited in this specification, and their references, are incorporated by reference herein in their entirety where appropriate for teachings of additional or alternative details, features, and/or technical background.

What is claimed is:

1. A single ion conductive copolymer of Formula I: 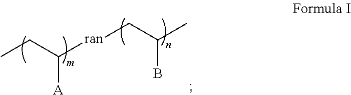
wherein monomer A is a single ion conducting monomer and monomer B is either a single ion conducting monomer or is a neutral monomer;
ran is a random copolymer structure;
m is an integer ranging from 1 to 5000; and
n is an integer ranging from 1 to 5000.

2. The single ion conductive copolymer of claim 1, wherein the monomer B is a single ion conducting monomer.

3. The single ion conductive copolymer of claim 1, wherein the monomer B is a neutral monomer.

4. The single ion conductive copolymer of claim 1, wherein one of the monomer A and the monomer B or both is a sulfonate monomer.

5. The single ion conductive copolymer of claim 1, wherein one of the monomer A and the monomer B or both is a fluorinated sulfonimide monomer.

6. The single ion conductive copolymer of claim 1, wherein one of the monomer A and the monomer B or both is a fluorinated sulfonyl carbamate monomer.

7. The single ion conductive copolymer of claim 1, wherein one of the monomer A and the monomer B or both is a fluorinated sulfonamide monomer.

8. The single ion conductive copolymer of claim 1, wherein one of the monomer A and the monomer B or both is a fluorinated sulfonylmethide monomer.

9. The single ion conductive copolymer of claim 1, wherein one of the monomer A and the monomer B or both is a fluorinated monocyclic borate monomer.

10. The single ion conductive copolymer of claim 1, wherein one of the monomer A and the monomer B or both is a fluorinated bicyclic borate monomer.

11. The single ion conductive copolymer of claim 1, wherein one of the monomer A and the monomer B or both is a fluorinated noncyclic borate monomer.

12. The single ion conductive copolymer of claim 1, wherein the monomer B is a styrene derivative.

13. The single ion conductive copolymer of claim 1, wherein the monomer B is an acrylate or a methacrylate derivative.

14. The single ion conductive copolymer of claim 1, wherein the monomer B is a vinyl carbonate derivative.

15. The single ion conductive copolymer of claim 1, wherein the monomer B is a vinyl monomer.

16. The single ion conductive copolymer of claim 1, having a formula selected from:

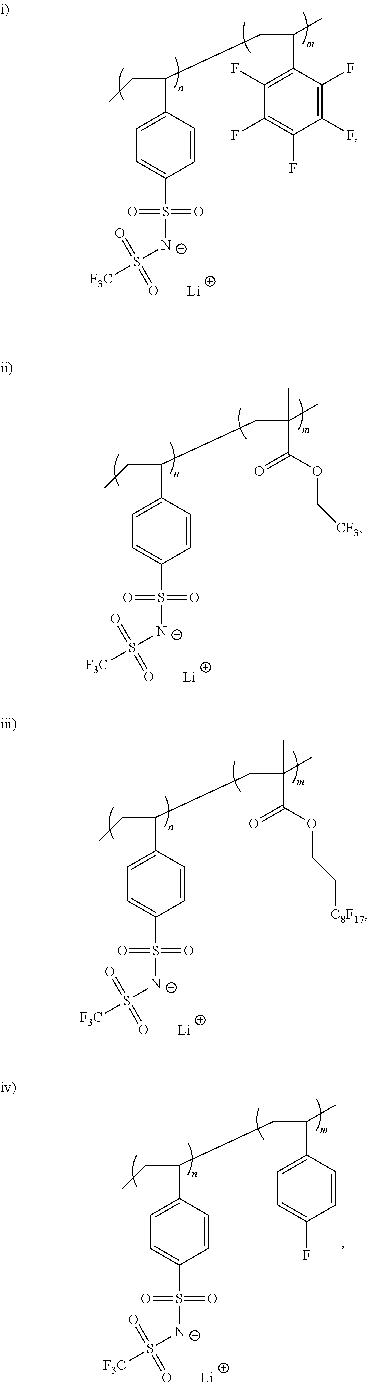

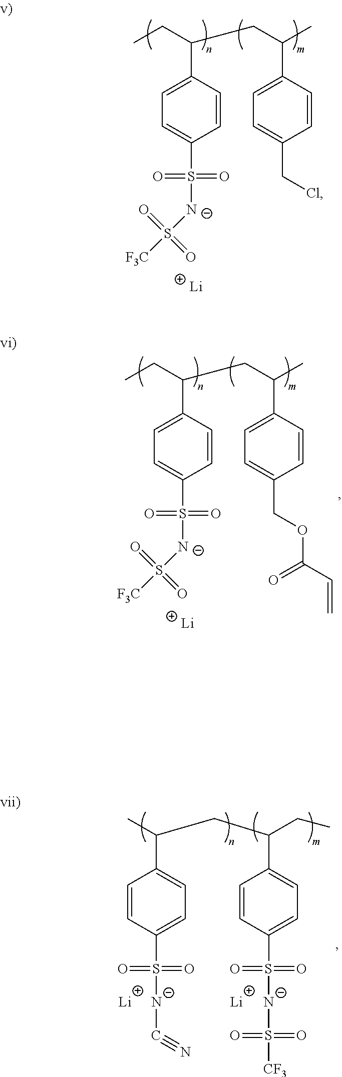

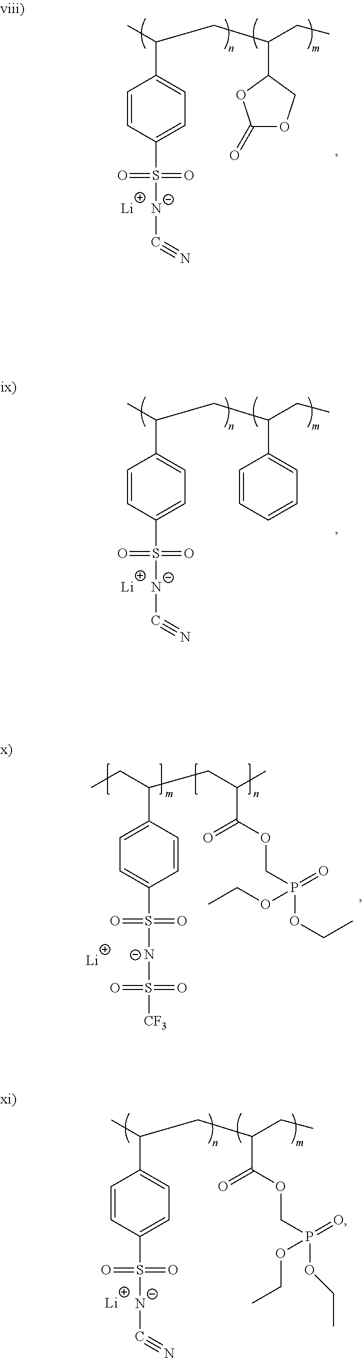

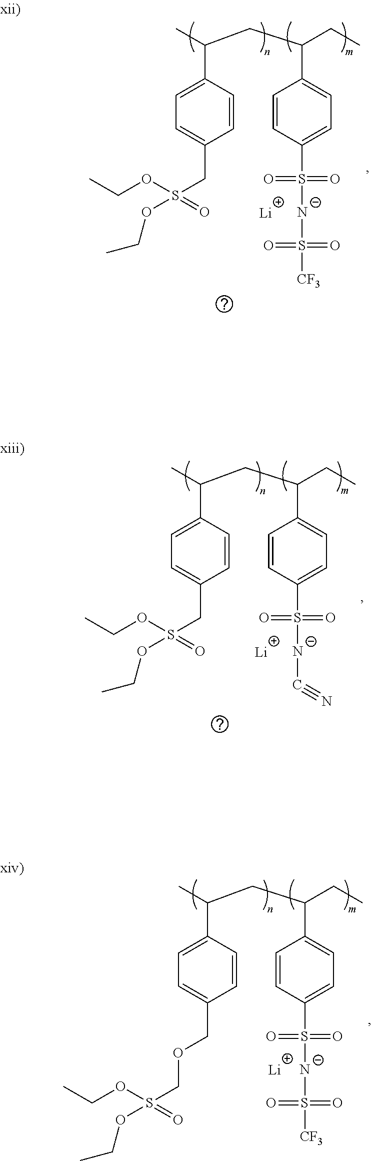

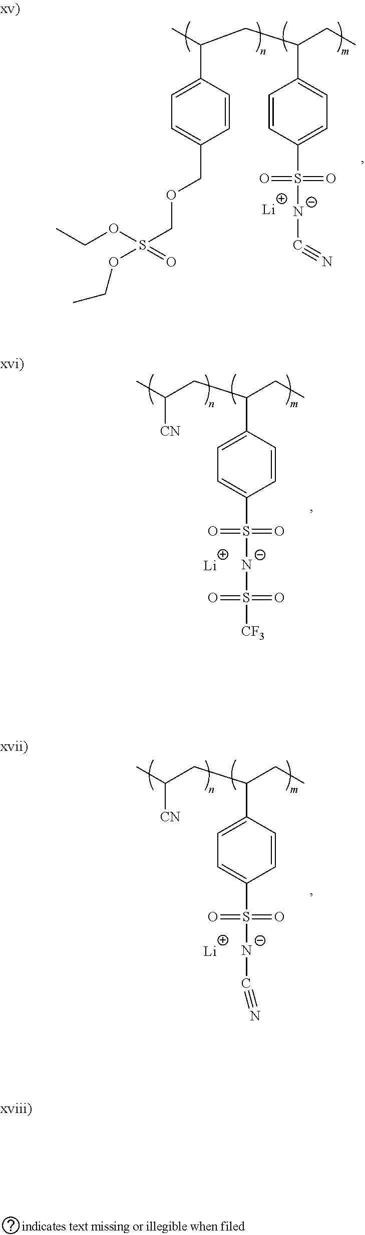

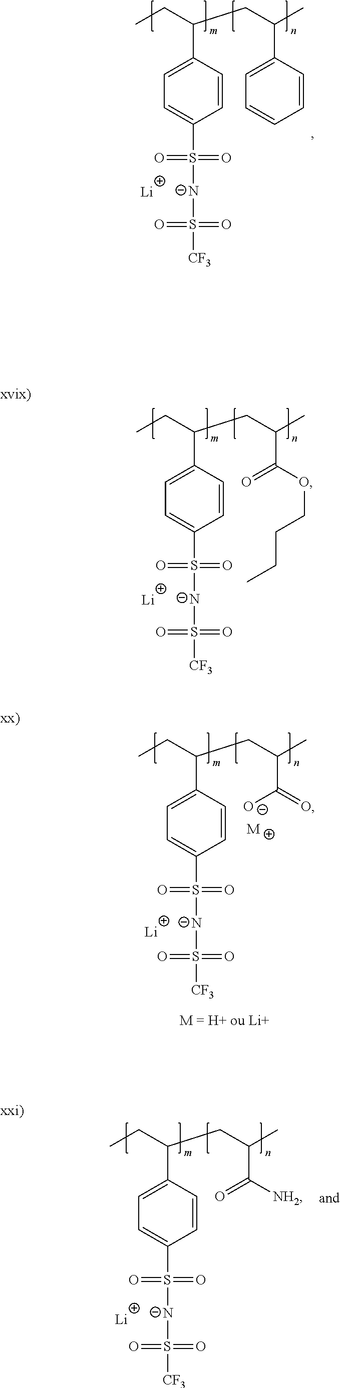

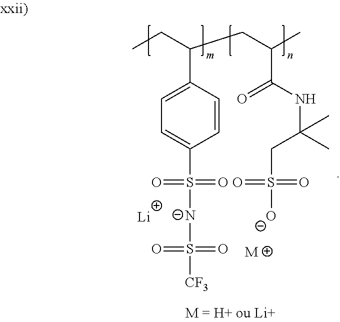

17. A single-ion conducting polymer electrolyte comprising the single ion conductive copolymer as defined in claim 1.

18. A single-ion conducting polymer cathode comprising the single ion conductive copolymer as defined in claim 1.

19. A single-ion conducting polymer anode comprising the single ion conductive copolymer as defined in claim 1.

20. A solid-state battery comprising:
i) a positive electrode, a negative electrode and the single-ion conducting polymer electrolyte of claim 17;
ii) the cathode of claim 18, a negative electrode and an electrolyte; or
iii) a positive electrode, the anode of claim 19 and an electrolyte.
